(19) United States
(12) Patent Application Publication
(10) Pub. No.: US 2015/0172194 A1
(43) Pub. Date: Jun. 18, 2015

(54) Traffic forwarding between geographically dispersed network sites

(71) Applicant: Hangzhou H3C Technologies Co., Ltd., Hangzhou, Zhejiang (CN)

(72) Inventors: Xiaoheng Song, Beijing (CN); Guoliang Zheng, Beijing (CN)

(73) Assignee: Hangzhou H3C Technologies Co., Ltd., Hangzhou, Zhejiang (CN)

(21) Appl. No.: 14/401,532

(22) PCT Filed: Aug. 9, 2013
(86) PCT No.: PCT/CN2013/081149

§ 371 Date: Nov. 16, 2014

(30) Foreign Application Priority Data
Oct. 18, 2012 (CN) 201210400707.2

(51) Int. Cl. H04L 12/801; H04L 12/46; H04L 12/721

(52) U.S. Cl. CPC H04L 47/12; H04L 45/66; H04L 12/4641

(57) ABSTRACT

The present disclosure describes traffic forwarding in a network where Virtual Local Area Networks (VLANs) are deployed over geographically dispersed sites. The network comprises a first edge device (ED) at a first site and a second ED at a second site. In one example, the first ED receives traffic from a host device within the first site. The received traffic is to be forwarded to the second ED via a virtual link established between the first ED and second ED. The first ED determines whether a bandwidth required by the received traffic exceeds a bandwidth threshold negotiated between the first ED and second ED for the first ED to forward traffic to the second ED via the virtual link. If the negotiated bandwidth threshold is not exceeded, the received traffic is forwarded to the second ED via the virtual link. Otherwise, traffic with high priority is selected from the received traffic and forwarded to the second ED via the virtual link.

### BACKGROUND

In order to improve reliability and provide redundancy, enterprise networks and data centres span across a number of geographically dispersed network sites. Similar services are deployed at the sites connected via layer 2 connectivity. To facilitate dynamic resource allocation and management, virtual machines are allowed to freely migrate among data centers. The process of virtual machine migration may be transparent to users and in which case their IP addresses remain unchanged.

### BRIEF DESCRIPTION OF DRAWINGS

By way of non-limiting examples, the present disclosure will be described with reference to the following drawings, in which:

FIG. 1 is a schematic diagram of an example network for traffic forwarding between geographically dispersed network sites;

FIG. 2 is a flowchart of an example method for traffic forwarding between geographically dispersed network sites;

FIG. 3 is a flowchart of an example implementation of bandwidth threshold negotiation and priority classification;

FIG. 4(a) is a flowchart of an example implementation of bandwidth threshold negotiation in FIG. 3;

FIG. 4(b) is a schematic diagram of an example notification message for bandwidth threshold negotiation;

FIG. 5(a) is a schematic diagram illustrating egress interfaces of a virtual link;

FIG. 5(b) is a schematic diagram illustrating the failure on a primary egress interface in FIG. 5(a); and

FIG. 6 is a schematic diagram of an example structure of a network device capable of acting as an edge device.

### DETAILED DESCRIPTION

In a network that includes geographically dispersed sites, traffic may be forwarded from one edge device at one site to another edge device at another site via a public network. For example, layer 2 traffic is first encapsulated with an Internet Protocol (IP) tunnel header before being forwarded to the destination edge device. When a failure or congestion occurs on a path in the public network, edge devices update and distribute their IP routing information to each other. In this case, depending on the convergence speed of the IP routing information, traffic may be lost or delayed while the IP routing information is updated and route calculation performed.

The present disclosure describes traffic forwarding in a network where Virtual Local Area Networks (VLANs) are deployed over geographically dispersed sites. The network comprises a first edge device (ED) at a first site and a second ED at a second site. In one example, the first ED receives traffic from a host device within the first site. The received traffic is to be forwarded to the second ED via a virtual link established between the first ED and second ED. The first ED determines whether a bandwidth required by the received traffic exceeds a bandwidth threshold negotiated between the first ED and second ED for the first ED to forward traffic to the second ED via the virtual link. If the negotiated bandwidth threshold is not exceeded, the received traffic is forwarded to the second ED via the virtual link. Otherwise, traffic with high priority is selected from the received traffic and forwarded to the second ED via the virtual link.

The above example of the present disclosure facilitates traffic forwarding based on bandwidth limitation and differentiated services in a network where VLANs are deployed over geographically dispersed sites. The negotiation of a bandwidth threshold for the first ED to forward traffic to the second ED provides the latter control over the amount of traffic sent by the former, which may reduce the likelihood of congestion. If the negotiated bandwidth threshold is exceeded, high priority traffic is selected for forwarding, for example to implement quality of service policies for this type of traffic.

Examples will be described with reference to accompanying drawings.

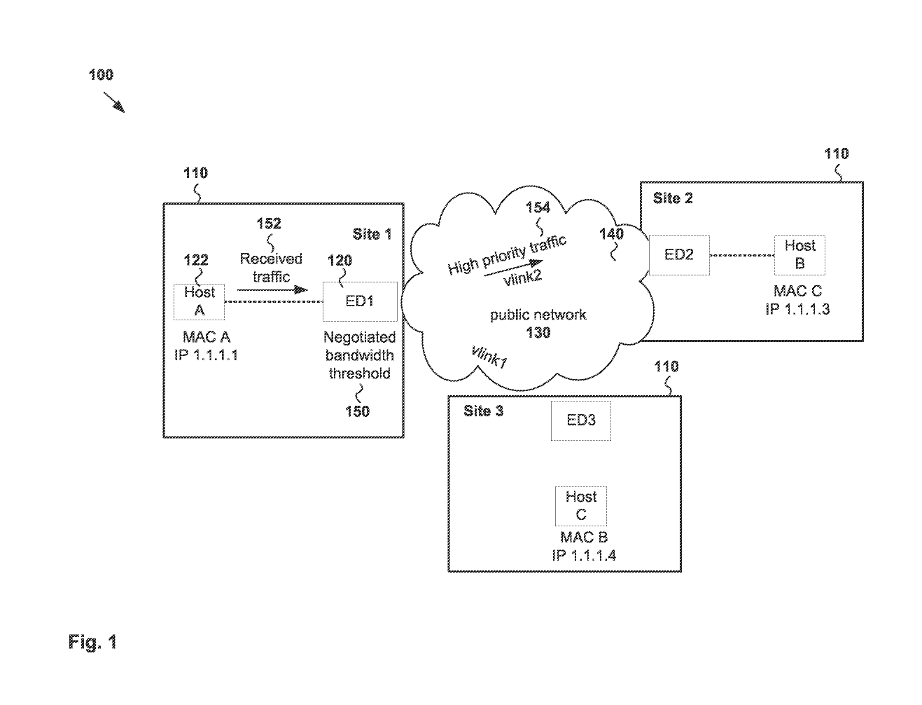

FIG. 1 is a schematic diagram of an example network 100 where a Virtual Local Area Networks (VLAN) may be deployed over geographical dispersed sites 110 (e.g. site 1, site 2, site 3). The network 100 includes multiple edge devices 120 (e.g. ED1, ED2, and ED3) that connect host devices 122 at respective sites 110 to a public network 130, which may be an Internet Protocol (IP) core network etc.

The edge devices 120 (e.g. ED1, ED2, ED3) perform traffic forwarding from the sites 110 to the public network 130, and vice versa. This allows host devices 122 connected to the edge devices 120 to send traffic, for example within a VLAN deployed over multiple sites 110. In FIG. 1, ED1, ED2 and ED3 connect hosts A (MAC address ‘MAC A’, IP address ‘1.1.1.1’), B (‘MAC B’, ‘1.1.1.3’) and C (‘MAC C’, ‘1.1.1.4’) to the public network 130 respectively. For example, host A and host B may belong to the same VLAN (e.g. VLAN100) deployed over site 1 and site 2, and ED1 and ED2 facilitates traffic forwarding between them.

The network 100 may employ suitable technology that provides layer 2 connectivity, such as Ethernet Virtual Interconnect (EVI) and Overlay Transport Virtualization (OTV) etc. EVI, for example, is a “MAC in IP” technology that provides layer 2 connectivity between distant layer 2 network sites across an IP core network. For example, EVI may be used to implement layer 2 virtual private network (L2VPN). Each EVI instance (also known as virtual interconnect instance) is assigned a unique network ID such that messages of different EVI instances are isolated from each other.

The example network 100 also includes an overlay network to facilitate communication between edge devices 120. The overlay network includes virtual links 140 (also referred to as “LINK”). The term “virtual link” 140 is used throughout the present disclosure to refer generally to a communication channel over a layer 3 network. In general, a physical communication medium may be virtualized to include multiple communication channels such that traffic of one communication channel is separated from that of a different one (e.g. using a suitable identifier).

In FIG. 1, virtual link ‘vlink2’ is established between ED1 and ED2, while ‘vlink1’ is established between ED1 and ED3. The virtual link 140 may be a layer 2 virtual link (e.g. virtual Ethernet link) tunnelled through a layer 3 public network using any suitable protocol (e.g. Generic Routing Encapsulation (GRE) etc.). For example, in an EVI network, an EVI link is a bidirectional virtual Ethernet channel between a pair of edge devices. An EVI tunnel may include multiple virtual links and generally refers to a communication channel between two edge devices 120 which may be of different EVI instances.

Once a virtual link is established, the edge devices advertise their routing information from which optimal paths may be calculated. When an edge device receives traffic from within a local site, the optimal path may be used to forward the traffic to its destination. The optimal path serves as an egress interface of the virtual link, via which traffic encapsulated with a tunnel header (e.g. IP GRE tunnel header) can be forwarded.

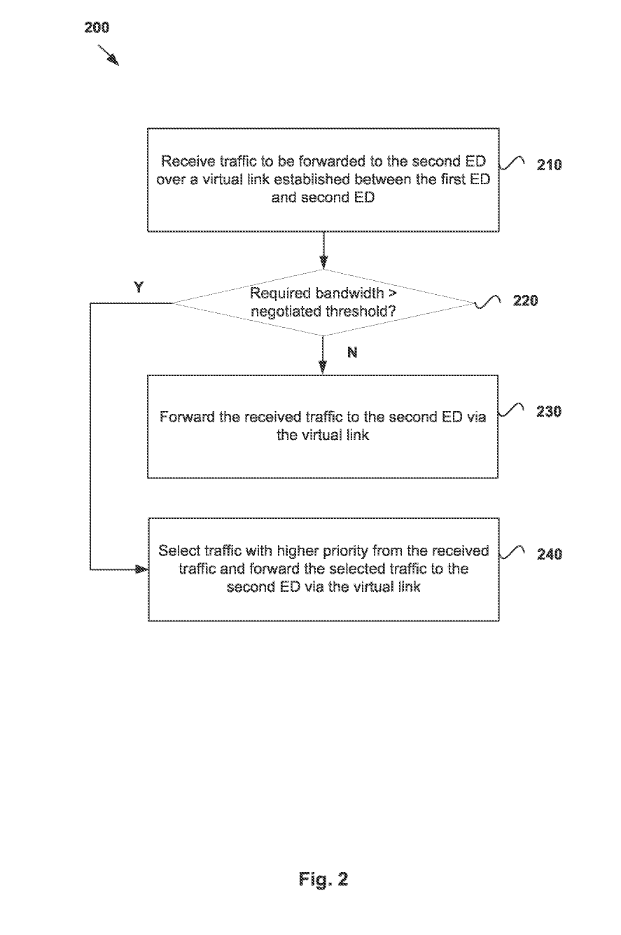

FIG. 2 is a flowchart of an example method 200 for traffic forwarding in a network 100 that includes a first ED (e.g. ED1) at a first site (e.g. site 1) and a second ED (e.g. ED2) at a second site (e.g. site 2). The example method 200 is applicable to the first ED (e.g. ED1).
At 210, the first ED (e.g. ED1) receives traffic from a host device (e.g. host A) within the first site (e.g. site 1). See 152 in FIG. 1. The received traffic is to be forwarded to the second ED (e.g. ED2) over a virtual link (e.g. vlink2) established between the first ED and second ED. For example, the traffic may include Ethernet data messages from the host A.
At 220, the first ED (e.g. ED1) determines whether a bandwidth required by the received traffic exceeds a negotiated bandwidth threshold. See 150 in FIG. 1. The threshold 150 is negotiated between the first ED (e.g. ED1) and the second ED (e.g. ED2) for the first ED to forward traffic to the second ED via the virtual link (e.g. vlink2)
At 230, if the negotiated bandwidth threshold 150 is not exceeded (i.e. required bandwidth is less than or equal to the negotiated bandwidth threshold), the first ED (e.g. ED1) forwards the received traffic to the second ED (e.g. ED2) via the virtual link (e.g. vlink2).
At 240, otherwise, if the negotiated bandwidth threshold 150 is exceeded, the first ED (e.g. ED1) selects traffic with high priority from the received traffic and forwards the selected traffic to the second ED (e.g. ED2) via the virtual link (e.g. vlink2). See 154 in FIG. 1.

According to the example in FIG. 2, the first ED and second ED are allowed to freely negotiate a bandwidth threshold 150, such that the first ED forwards traffic to the second ED according to the negotiated threshold. This may reduce if not avoid the likelihood of burdening the virtual link with traffic that cannot be supported by the second ED. This in turn reduces the likelihood of congestion over the virtual link and/or at the second ED.

If the bandwidth required by the received traffic 152 exceeds the negotiated bandwidth threshold 150, high priority traffic 154 is selected for forwarding, for example to achieve quality of service parameters for such traffic. The example in FIG. 2 therefore facilitates the implementation of differentiated services in a network 100 with multiple geographically dispersed network sites 110.

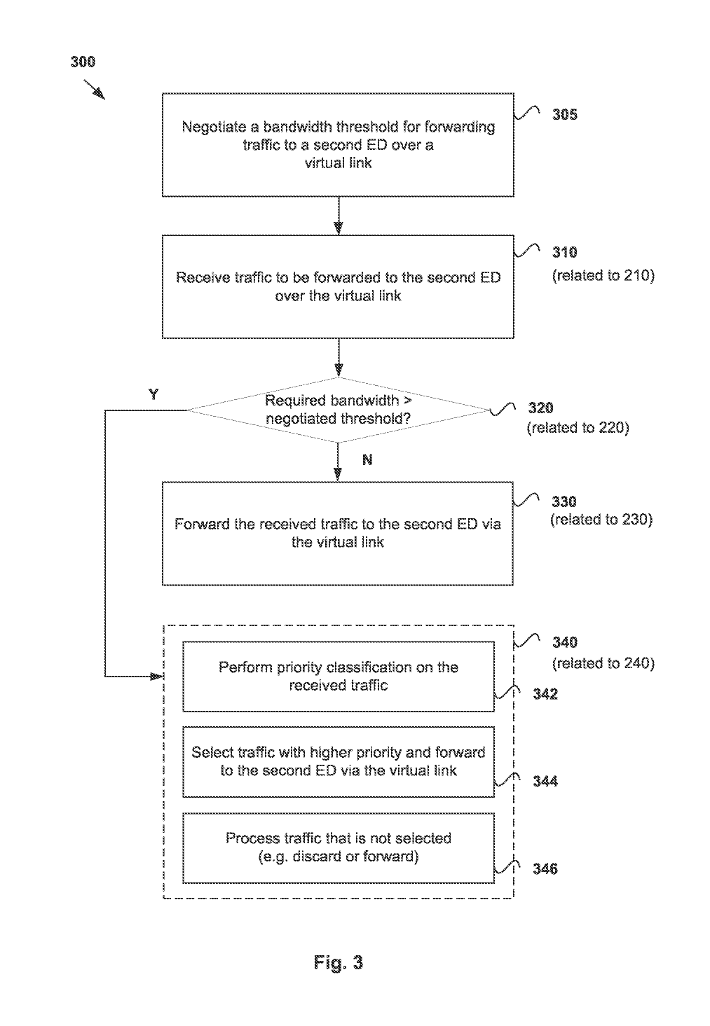

It will be appreciated that the “first ED” and “second ED” may be any pair of edge devices in the network 100 that communicate over a virtual link between them. The terms “first” and “second” are merely used to distinguish different edge devices, and should not be taken as an indication of any sequence or order. Example implementations of the blocks in FIG. 2 will now be discussed with reference to FIG. 3 to FIG. 6.

Negotiation of Bandwidth Threshold

Referring now to FIG. 3, a negotiation process 305 may be performed by the first ED prior to receiving the traffic from the host device (e.g. host A). In particular, at 305, the first ED (e.g. ED1) negotiates with the second ED (e.g. ED2) a bandwidth threshold for the first ED to forward traffic to the second ED over the virtual link established between them (e.g. vlink2). See negotiated bandwidth threshold 150 in FIG. 1 (also referred to as “available bandwidth threshold of the LINK”).

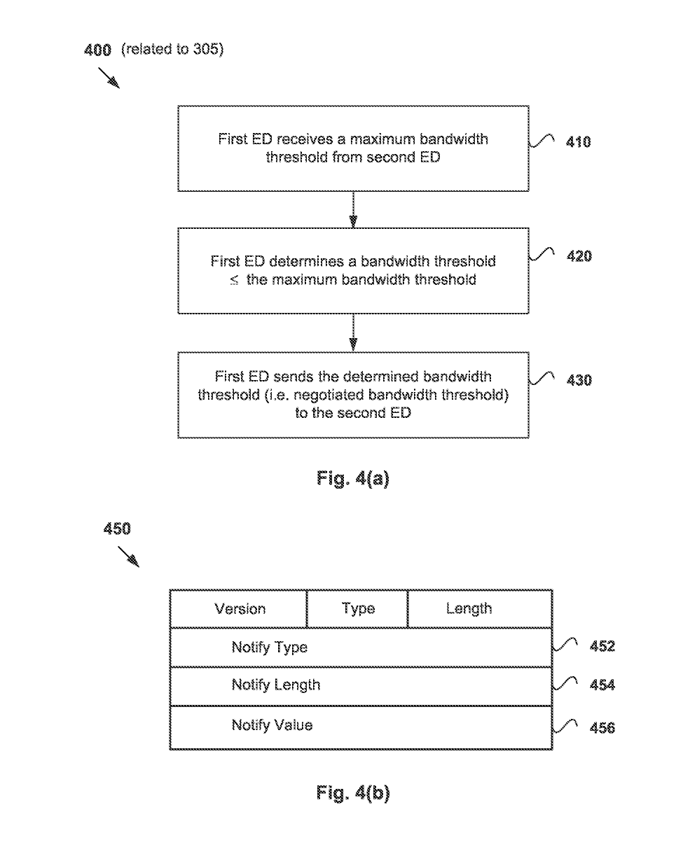

Referring also to FIG. 4(a), the negotiation process between the first ED (e.g. ED1) and second ED (e.g. ED2) at 305 in FIG. 3 may include the following.
At 410, the first ED (e.g. ED1) receives a maximum bandwidth threshold supported by the second ED (e.g. ED2) over the virtual link (e.g. vlink2).
At 420, based on the maximum bandwidth threshold, the first ED (e.g. ED1) determines an available bandwidth threshold that is less than or equal to the maximum bandwidth threshold.
At 430, the first ED (e.g. ED1) sends the determined bandwidth threshold (i.e. the negotiated bandwidth threshold) to the second ED (e.g. ED2). The negotiated bandwidth threshold is for the first ED (e.g. ED1) to send traffic to the second ED (e.g. ED2) over the virtual link (e.g. vlink2).

Similarly, the second ED (e.g. ED2) may negotiate a bandwidth threshold for the second ED to forward traffic to the first ED (e.g. ED1) via the virtual link (e.g. vlink2) established between them according to the example in FIG. 4(a). This way, when the second ED (e.g. ED2) forwards traffic received from a local site (e.g. from host B at site 2) to the first ED (e.g. ED1) via the virtual link (e.g. vlink2), the received traffic will be forwarded based on the negotiated bandwidth threshold.

The maximum bandwidth threshold may be received at 410 via a notification message, an example 400 of which is shown in FIG. 4(b). In this case, the message 450 is a virtual link Notify message that has additional fields to specify the bandwidth information. The ‘Notify Type’ field 452 indicates that the message is for bandwidth notification. The ‘Notify Length’ field 454 indicates the length of the field and ‘Notify Value’ field 456 indicates the bandwidth threshold set by the sending edge device 120.

In one example, the negotiated bandwidth threshold may be the total bandwidth threshold for all traffic types, such as broadcast traffic, multicast traffic, unicast traffic, unknown unicast traffic (e.g. unknown MAC address), and unknown multicast traffic etc. Alternatively or additionally, different bandwidth thresholds may also be set for different traffic types. However, when added together, the total of all different thresholds should not exceed the total bandwidth threshold for all traffic types.

For each traffic type (or group of traffic types), a different maximum bandwidth threshold and negotiated bandwidth threshold may be set. For example, the bandwidth used by unicast traffic should not exceed the negotiated threshold for unicast traffic, the bandwidth used by multicast traffic should not exceed the negotiated threshold for multicast traffic, etc. In this case, the comparison between the required bandwidth and negotiated bandwidth threshold at 220 in FIG. 2 may further include the following.
The first ED (e.g. ED1) determines the type of the received traffic (e.g. unicast traffic) and bandwidth required for the received traffic.
The first ED (e.g. ED1) compares the bandwidth required for the received traffic with the negotiated bandwidth threshold for the type of the received traffic (e.g. threshold for unicast traffic).

If the negotiated threshold for the traffic type is not exceeded, the first ED (e.g. ED1) forwards the received traffic to the second ED (e.g. ED2) via the virtual link (e.g. vlink2) established between them; see 230 in FIGS. 2 and 330 in FIG. 3. Otherwise (negotiated threshold exceeded), the first ED (e.g. ED1) selects traffic with high priority (e.g. high priority unicast traffic) and forwards the selected traffic to the second ED (e.g. ED2); see 240 in FIGS. 2 and 340 in FIG. 3.

In the above example, even if the bandwidth required for the unicast traffic exceeds the threshold for unicast traffic but not the total for all types of traffic, the threshold is considered to have been exceeded and unicast traffic with high priority is selected for forwarding.

The type of traffic (e.g. unicast, broadcast, multicast, unknown etc.) to be forwarded may be determined based on information in the received traffic. For example, layer 2 (link layer), layer 3 (network layer) and layer 4 (transport layer) information may be used, such as source MAC address, destination MAC address, 802.1p information, Virtual Local Area Network (VLAN) ID, Ethernet protocol type, Virtual Private Network (VPN) instance, EXP etc. In practice, the type of traffic may also be pre-determined.

The negotiation process may be performed dynamically or periodically, and/or involve several rounds. By negotiating different thresholds for different traffic types, bandwidth usage of a particular traffic type may be limited depending on dynamic network conditions. For example, if flooding of unknown traffic in the public network 130 is to be limited, a maximum bandwidth threshold of zero may be set for unknown unicast and/or multicast traffic.

Priority Classification

Example implementations of blocks 230 and 240 in FIG. 2 will now be explained with reference to corresponding blocks 330 and 340 in FIG. 3.

At 342 in FIG. 3, the first ED (e.g. ED1) may perform priority classification on the received traffic (e.g. Ethernet data messages). Priority classification may be performed according to any suitable static and dynamic policy. For example, a message may be assigned a priority class based on information in the message, such as the VLAN ID, source MAC address, destination MAC address etc.

Using the source MAC address as an example, a priority class may be assigned to a source MAC address (or a range of addresses). In this case, when an edge device 120 receives a message, the edge device assigns a priority class to the message based on its source MAC address regardless any priority information carried by the message. Similar approach may be used for other priority classification criteria.

At 344 in FIG. 3, the first ED (e.g. ED1) then selects traffic for forwarding based on the traffic classification at 342. At 346, traffic that is not selected (e.g. lower priority traffic) may be discarded. In one example, after a virtual link (e.g. vlink2) is established between the first ED (e.g. ED1) and second ED (e.g. ED2), an egress interface having an optimal path may be selected as the next-hop interface. The optimal path may be selected based on routing information available to the first ED. When forwarding the received traffic via the virtual link (e.g. based on outgoing VLAN, outgoing port, outgoing tunnel), the traffic is forwarded via the egress interface having the optimal path.

If the bandwidth required by the received traffic exceeds the negotiated bandwidth threshold, high priority traffic is selected for forwarding via the egress interface having the optimal path. At 346 in FIG. 3, the traffic that is not selected is discarded or its forwarding delayed. The traffic that is not selected generally has a lower priority and lower quality of service.

Primary and Backup Egress Interfaces

In one example, load sharing and link protection may be implemented by allocating multiple egress interfaces for a virtual link between the first ED and second ED. The allocation of egress interfaces may be based on route calculation and routing information. Each egress interface may be a logical interface representing a different path from the first ED to the second ED. The egress interface serves as a next-hop interface, as determined based on any suitable criteria such as outgoing VLAN, outgoing port and outgoing tunnel number etc.

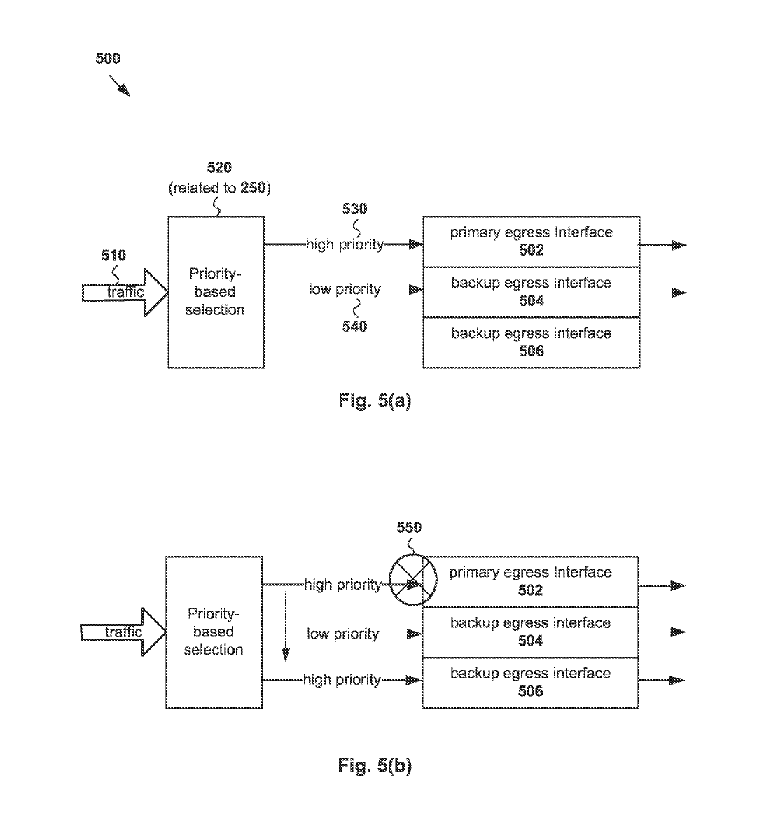

Referring now to FIG. 5(a), load is shared among multiple egress interfaces. An egress interface having an optimal path is selected from the multiple egress interfaces as a “primary egress interface” 502. The remaining egress interface not having the optimal path may serve as backup egress interface 504 (or “secondary egress interface”). If the bandwidth required by the received traffic 510 exceeds the negotiated bandwidth threshold, traffic selected 520 as high priority traffic 530 is forwarded via the primary egress interface 502. Traffic that is not selected (low priority traffic 540) may be discarded or forwarded via any backup egress interface 504.

To further improve the effectiveness of link protection, multiple backup egress interfaces 504 may be provided. Each backup egress interface 504 represents a secondary path from the first ED to the second ED, and different priority designation and bandwidth limitation may be implemented for each secondary path.

Referring also to FIG. 5(b), the role of the primary egress interface may be switched among the egress interfaces depending on network conditions. This serves to improve the reliability of traffic forwarding and provide link protection in the network. This may involve the first ED determining whether there is a failure on the primary egress interface 502. Upon detecting a failure, the first ED selects a backup egress interface 504 to operate temporarily in place of the primary egress interface 502. The selected backup egress interface 504 may be referred to as the “temporary egress interface”. See also 550 in FIG. 5(b).

To facilitate high speed packet switching, any suitable failure detection mechanism may be used on the virtual link, such as Bidirectional Forwarding Detection (BFD) etc. BFD may be performed on the source end or destination end of a tunnel. Failure detection may be performed periodically or dynamically depending on the application. When failure or congestion is detected, traffic to be forwarded via the primary egress interface 502 will be switched to the temporary egress interface 506.

According to optimal path forwarding principles, the temporary egress interface 506 may also be replaced by a new optimal egress interface if the latter is associated with the optimal path. This may involve the first ED selecting an egress interface associated with an optimal path (e.g. based on routing information received by the first ED etc.) as the new optimal egress interface. The first ED then determines whether the egress interface associated with the optimal path is the temporary egress interface 506.
If yes (i.e. the temporary egress interface 506 is associated with the optimal path), upgrading the temporary egress interface 506 as the primary egress interface 502.
Otherwise (i.e. the temporary egress interface 506 is not associated with the optimal path), controlling the temporary egress interface 506 to stop operating in place of the primary egress interface 502 and upgrading the backup egress interface associated with the optimal path as the primary egress interface 502. If the previous primary egress interface 502 has recovered from failure, it may be re-instated as the primary egress interface 502 accordingly.

It should be understood that the primary egress interface 502 and each backup egress interface 504 may be limited by a statically configured available bandwidth threshold. When selecting the temporary egress interface 506, the maximum bandwidth threshold of the temporary egress interface 506 may be greater than that of the primary egress interface 502 to reduce or avoid further congestion. Of course, if the temporary egress interface 506 has insufficient bandwidth for forwarding all the received traffic, the received traffic may be classified according to their priority and sent via other backup egress interface 504.

Although two classes of priority (high and low) are used as examples throughout the present disclosure, it will be appreciated that depending on the applications, there may be additional classes or sub-classes to represent different quality of services.

Example Network Devices 600

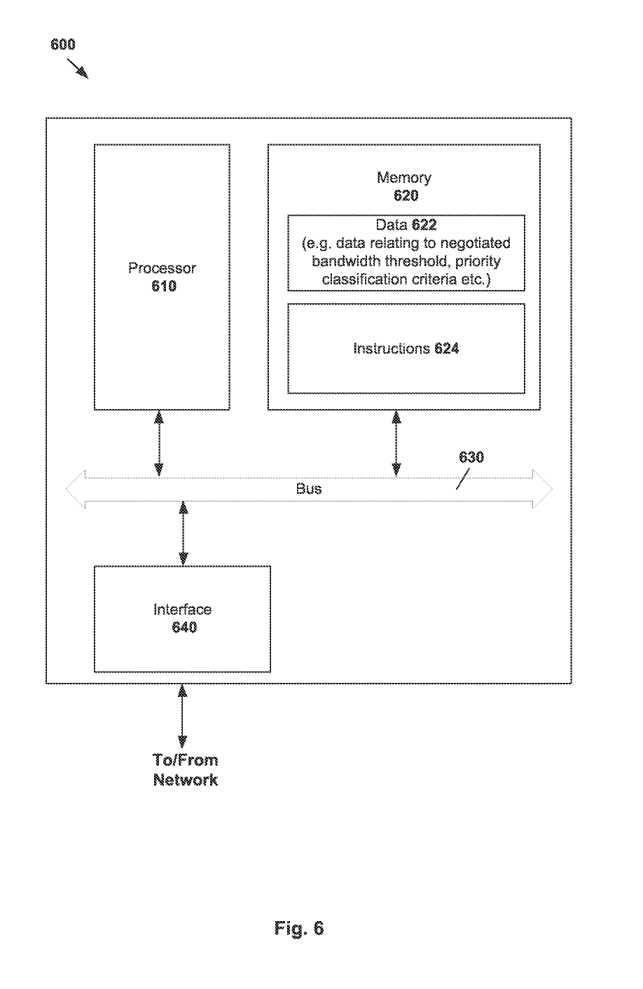

The above examples can be implemented by hardware, software or firmware or a combination thereof. Referring to FIG. 6, an example network device 600 that includes a processor 610, a memory 620 and a network interface device 640 that communicate with each other via bus 630. The processor 610 is to perform processes described herein with reference to FIG. 1 to FIG. 5.

In one example, the network device 600 is capable of acting as a first ED (e.g. ED1 in FIG. 1), in which case the processor is to:
Receive traffic from a host device within the first site. The received traffic is to be forwarded to the second ED via a virtual link established between the first ED and second ED.
Determine whether a bandwidth required by the received traffic exceeds a bandwidth threshold negotiated between the first ED and second ED for the first ED to forward traffic to the second ED via the virtual link.
If the negotiated bandwidth threshold is not exceeded, forward the received traffic to the second ED via the virtual link, but otherwise, select traffic with high priority from the received traffic and forward the selected traffic to the second ED via the virtual link.

The memory 620 may store any necessary data 622 for facilitating traffic forwarding between geographically dispersed network sites. For example, the data 622 includes information relating to the negotiated bandwidth threshold, priority classification criteria, etc.

The memory 620 may store machine-readable instructions 624 executable by the processor 610 to cause the processor 610 to perform processes described herein with reference to FIG. 1 to FIG. 6. In one example, when the network device 600 is acting as a first ED (e.g. ED1 in FIG. 1), the instructions 624 include:
Receiving instruction to receive traffic from a host device within the first site. The received traffic is to be forwarded to the second ED via a virtual link established between the first ED and second ED.
Forwarding instruction to determine whether a bandwidth required by the received traffic exceeds a bandwidth threshold negotiated between the first ED and second ED for the first ED to forward traffic to the second ED via the virtual link.
The forwarding instruction is further to, if the negotiated bandwidth threshold is not exceeded, forward the received traffic to the second ED via the virtual link. But otherwise, the forwarding instruction is to select traffic with high priority from the received traffic and forward the selected traffic to the second ED via the virtual link.

The instructions 624 may further include appropriate instruction to perform the processes described throughout the present disclosure. The instructions 624 may be combined and divided to perform various processes as appropriate.

In a further example, the network device 600 may include various units to implement the processes described throughout the disclosure. The units may include a negotiation unit, a receiving unit, and a forwarding unit (not shown for simplicity).
Receiving unit to receive traffic from a host device within the first site. The received traffic is to be forwarded to the second ED via a virtual link established between the first ED and second ED.
Forwarding unit to determine whether a bandwidth required by the received traffic exceeds a bandwidth threshold negotiated between the first ED and second ED for the first ED to forward traffic to the second ED via the virtual link.
The forwarding unit is to, if the negotiated bandwidth threshold is not exceeded, forward the received traffic to the second ED via the virtual link, but otherwise, select traffic with high priority from the received traffic and forward the selected traffic to the second ED via the virtual link.

Prior to receiving the traffic, the network device 600 (e.g. via processor 610, instruction, unit) may be further to negotiate with the second ED the bandwidth threshold for the first ED to forward traffic to the second ED via the virtual link established between them.

When negotiating the bandwidth threshold, the network device 600 (e.g. via processor 610, instruction, unit) may be to receive, from the second ED, a maximum bandwidth threshold supported by the second ED over the virtual link; determine a bandwidth threshold that is less than or equal to the maximum bandwidth threshold; and send the determined bandwidth threshold, being the negotiated bandwidth threshold, to the second ED. If the negotiated bandwidth threshold is exceeded, traffic that is not selected for forwarding may be discarded.

Further, the network device 600 (e.g. via processor 610, an instruction, a unit) may be to allocate multiple egress interfaces for the virtual link; select one of the egress interfaces associated with an optimal path to the second ED as a primary egress interface and each of the rest as a backup egress interface; and when forwarding the received traffic or selected traffic with high priority to the second ED, forward via the primary egress interface of the virtual link.

In this case, if the negotiated bandwidth threshold is exceeded, the network device 600 (e.g. via processor 610, instruction, unit etc.) may be to forward the remaining traffic that is not selected as traffic with high priority to the second ED via a backup egress interface.

The network device 600 (e.g. via processor 610, instruction, unit etc.) may be to: detect whether there is a failure on the primary egress interface; and upon detecting a failure, select a backup egress interface as a temporary egress interface to operate temporarily in place of the primary egress interface. In this case, a new optimal egress interface of the virtual link having an optimal path to the second ED may be determined. If the temporary egress interface is not the new optimal egress interface, control the temporary egress interface stop operating in place of the primary egress interface, and upgrade the new optimal egress interface as the primary egress interface; but otherwise, upgrade the temporary egress interface as the primary egress interface.

In another example, the network device 600 (e.g. via processor 610, instruction, unit etc.) may be a forwarding device for use as an ED in EVI networking. The device may comprise:
A negotiation unit, for negotiating with an opposite end ED an available bandwidth threshold to send EVI data messages to the opposite end ED over the LINK after said ED establishes a virtual connection LINK with the opposite end
ED.
A receiving unit, for receiving Ethernet data messages from a host within the local site.
A classification unit, for carrying out priority classification for the received Ethernet data messages.
A forwarding unit, for determining that all the received Ethernet data messages need to enter the LINK to be forwarded; if the bandwidth occupied by all the received Ethernet data messages is greater than the available bandwidth threshold of the LINK, under the premise that the bandwidth occupied by the data messages entering the LINK is smaller than or equal to the available bandwidth threshold of the LINK, selecting in preference a message having a high priority from all the received Ethernet data messages to enter the LINK to be forwarded; if the bandwidth occupied by all the received Ethernet data messages is smaller than or equal to the available bandwidth threshold of the LINK, letting all the received Ethernet data messages enter the LINK to be forwarded.

The methods, processes and units described herein may be implemented by hardware (including hardware logic circuitry), software or firmware or a combination thereof. The term ‘processor’ is to be interpreted broadly to include a processing unit, ASIC, logic unit, or programmable gate array etc. The processes, methods and functional units may all be performed by the one or more processors 710; reference in this disclosure or the claims to a ‘processor’ should thus be interpreted to mean ‘one or more processors’.

Although one network interface device 640 is shown in FIG. 6, processes performed by the network interface device 640 may be split among multiple network interface devices (not shown for simplicity). As such, reference in this disclosure to a ‘network interface device’ should be interpreted to mean ‘one or more network interface devices”.

Further, the processes, methods and functional units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

Throughout the present disclosure, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for traffic forwarding in a network where Virtual Local Area Networks (VLANs) are deployed over geographically dispersed sites, wherein the network comprises a first edge device (ED) at a first site and a second ED at a second site, and the method comprises the first ED:
receiving traffic from a host device within the first site, wherein the traffic is to be forwarded to the second ED via a virtual link established between the first ED and second ED;
determining whether a bandwidth required by the received traffic exceeds a bandwidth threshold negotiated between the first ED and second ED for the first ED to forward traffic to the second ED via the virtual link; and
if the negotiated bandwidth threshold is not exceeded, forwarding the received traffic to the second ED via the virtual link, but otherwise, selecting traffic with high priority from the received traffic and forwarding the selected traffic to the second ED via the virtual link.

2. The method of claim 1, further comprising, prior to receiving the traffic, negotiating with the second ED the bandwidth threshold for the first ED to forward traffic to the second ED via the virtual link.

3. The method of claim 2, wherein negotiating with the second ED further comprises:
receiving, from the second ED, a maximum bandwidth threshold supported by the second ED over the virtual link;
determining a bandwidth threshold that is less than or equal to the maximum bandwidth threshold; and
sending the determined bandwidth threshold, being the negotiated bandwidth threshold, to the second ED.

4. The method of claim 1, further comprising, if the negotiated bandwidth threshold is exceeded, discarding traffic that is not selected for forwarding.

5. The method of claim 1, wherein the method further comprises:
allocating multiple egress interfaces for the virtual link;
selecting one of the egress interfaces associated with an optimal path to the second ED as a primary egress interface and each of the rest as a backup egress interface; and
when forwarding the received traffic or selected traffic with high priority to the second ED, forwarding via the primary egress interface of the virtual link.

6. The method of claim 5, wherein if the negotiated bandwidth threshold is exceeded, forwarding the remaining traffic that is not selected as traffic with high priority to the second ED via a backup egress interface.

7. The method of claim 5, further comprising:
detecting whether there is a failure on the primary egress interface; and
upon detecting a failure, selecting a backup egress interface as a temporary egress interface to operate temporarily in place of the primary egress interface.

8. The method of claim 7, further comprising:
determining a new optimal egress interface of the virtual link having an optimal path to the second ED;
if the temporary egress interface is not the new optimal egress interface, stopping its operation and upgrading the new optimal egress interface as the primary egress interface; but otherwise, upgrading the temporary egress interface as the primary egress interface.

9. A network device for traffic forwarding in a network where Virtual Local Area Networks (VLANs) are deployed over geographically dispersed sites, wherein the network device is capable of acting as the first ED and comprises a processor to:
receive traffic from a host device within the first site, wherein the traffic is to be forwarded to the second ED via a virtual link established between the first ED and second ED;
determine whether a bandwidth required by the received traffic exceeds a bandwidth threshold negotiated between the first ED and second ED for the first ED to forward traffic to the second ED via the virtual link; and
if the negotiated bandwidth threshold is not exceeded, forward the received traffic to the second ED via the virtual link, but otherwise, select traffic with high priority from the received traffic and forward the selected traffic to the second ED via the virtual link.

10. The network device of claim 9, wherein the processor is further to, prior to receiving the traffic, negotiate with the second ED the bandwidth threshold for the first ED to forward traffic to the second ED via the virtual link.

11. The network device of claim 9, wherein the processor is further to, if the negotiated bandwidth threshold is exceeded, discard traffic that is not selected for forwarding.

12. The network device of claim 9, wherein the processor is further to:
allocate multiple egress interfaces for the virtual link;
select one of the egress interfaces associated with an optimal path to the second ED as a primary egress interface and each of the rest as a backup egress interface; and
when forwarding the received traffic or selected traffic with high priority to the second ED, forward via the primary egress interface of the virtual link.

13. The network device of claim 12, wherein the processor is further to, if the negotiated bandwidth threshold is exceeded, forward the remaining traffic that is not selected as traffic with high priority to the second ED via a backup egress interface.

14. The network device of claim 12, wherein the processor is further to:
detect whether there is a failure on the primary egress interface; and
upon detecting a failure, select a backup egress interface as a temporary egress interface to operate temporarily in place of the primary egress interface.

15. The network device of claim 14, wherein the processor is further to:
determine a new optimal egress interface of the virtual link having an optimal path to the second ED;
if the temporary egress interface is not the new optimal egress interface, control the temporary egress interface stop operating in place of the primary egress interface, and upgrade the new optimal egress interface as the primary egress interface; but otherwise, upgrade the temporary egress interface as the primary egress interface.
